(19) United States
(12) Patent Application Publication
(10) Pub. No.: US 2023/0236681 A1
(43) Pub. Date: Jul. 27, 2023

(54) WHEEL DEVICE AND MOUSE

(71) Applicant: DARFON ELECTRONICS CORP., Taoyuan City (TW)

(72) Inventors: Chao-Yu Chen, Taoyuan City (TW); Shao-Lun Hsiao, Taoyuan City (TW)

(73) Assignee: DARFON ELECTRONICS CORP., Taoyuan City (TW)

(21) Appl. No.: 18/079,002

(22) Filed: Dec. 12, 2022

Related U.S. Application Data
(60) Provisional application No. 63/303,511, filed on Jan. 27, 2022.

(30) Foreign Application Priority Data
Nov. 25, 2022 (TW) 111145109

(51) Int. Cl. G06F 3/0362; G06F 3/0354

(52) U.S. Cl. CPC G06F 3/0362; G06F 3/03543; G06F 2203/0333

(57) ABSTRACT

A wheel device is applied to a mouse and includes a supporter, a wheel module, a lighting unit and a sheltering component. The wheel module includes a wheel axle, an encoder and a wheel component. The wheel axle includes an axle body, a wheel surface and a wheel frame. The axle body is rotatably disposed on the supporter and on center of the wheel frame. The wheel surface is located on an outer surface of the wheel frame. The encoder is connected to the axle body to detect rotation parameters of the wheel axle. The wheel component covers the wheel surface. The lighting unit is disposed on the supporter and inside the wheel frame, and emits an illumination beam to the wheel module. The sheltering component is disposed on the supporter and covers the lighting unit to prevent the illumination beam from leakage through two sides of the wheel component.

### CROSS REFERENCE TO RELATED APPLICATIONS

This application claims the benefit of U.S. Provisional Application No. 63/303,511, filed on Jan. 27, 2022. The content of the application is incorporated herein by reference.

### BACKGROUND OF THE INVENTION

### 1. Field of the Invention

The present invention relates to a wheel device and a mouse, and more particularly, to a wheel device and a mouse of preventing beam leakage.

### 2. Description of the Prior Art

A wheel module disposed on the top of the mouse is used to control a gesture applied for browsing the webpage. The user can control a rotary speed of the wheel via fingers, and the rotary speed of the wheel is relevant to a rolling speed of the webpage and information content that the user can watch within a short period. The rotary speed of the wheel is detected by an encoder. The wheel is made of transparent material, and a lighting unit is disposed inside the wheel. An illumination beam emitted by the lighting unit is reflected by an inner wall of the wheel to illuminate the wheel; however, a gap is formed between the wheel and the mouse case, to ensure that the wheel is not interfered with the mouse case during rotation. The illumination beam of the lighting unit is easily leaked out of the mouse case through the gap, which results in the worst illumination effect of the wheel and the worst artistic appearance of the mouse.

### SUMMARY OF THE INVENTION

The present invention provides a wheel device and a mouse of preventing beam leakage for solving above drawbacks.

According to the claimed invention, a wheel device includes a supporter, a wheel module, a lighting unit and a sheltering component. The wheel module includes a wheel axle, an encoder and a wheel component. The wheel axle includes an axle body, a wheel surface and a wheel frame. The axle body is rotatably disposed on the supporter and further on a center of the wheel frame, and the wheel surface is located on an outer surface of the wheel frame. The encoder is disposed adjacent to the axle body and adapted to detect rotation parameters of the wheel axle. The wheel component covers the wheel surface. The lighting unit is disposed on the supporter and located inside the wheel frame, and adapted to emit an illumination beam to the wheel module. The sheltering component is disposed on the supporter and adapted to cover the lighting unit for preventing the illumination beam from leakage through two sides of the wheel component.

According to the claimed invention, a mouse includes a case and a wheel device. The wheel device is disposed inside the case. The wheel device includes a supporter, a wheel module, a lighting unit and a sheltering component. The wheel module includes a wheel axle, an encoder and a wheel component. The wheel axle includes an axle body, a wheel surface and a wheel frame. The axle body is rotatably disposed on the supporter and further on a center of the wheel frame, and the wheel surface is located on an outer surface of the wheel frame. The encoder is disposed adjacent to the axle body and adapted to detect rotation parameters of the wheel axle. The wheel component covers the wheel surface. The lighting unit is disposed on the supporter and located inside the wheel frame, and adapted to emit an illumination beam to the wheel module. The sheltering component is disposed on the supporter and adapted to cover the lighting unit for preventing the illumination beam from leakage through two sides of the wheel component.

The wheel device and the mouse of the present invention can cover the sheltering component on the lighting unit inside the wheel module. The sheltering component can guide the illumination beam of the lighting unit to project onto the wheel frame of the wheel axle inside the wheel module, and further can avoid the illumination beam from leakage through the sides of the wheel component inside the wheel module. The sheltering component can be only the arch portion used to cover the lighting unit, or be a combination of the arch portion and the stretching portion used to increase the installation stability, or be a combination of the arch portion, the stretching portion and the axle covering portion used to provide preferred covering effect. The section of the sheltering component is not limited to the bending structure, the arc structure and the inclined plate structure mentioned as above. Any sheltering component of preventing the illumination beam from leakage through the opening on the case without hindering the normal operation of the wheel module can be applied for the wheel device and the related mouse of the present invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of a part of a mouse according to an embodiment of the present invention.

FIG. 2 and FIG. 3 are diagrams of a wheel device in different views according to the embodiment of the present invention.

FIG. 4 to FIG. 6 are diagrams of a sheltering component according to different embodiments of the present invention.

FIG. 7 is a diagram of the sheltering component and a related sectional structure according to the embodiment of the present invention.

FIG. 8 and FIG. 9 are sectional views of the sheltering component according to other embodiments of the present invention.

### DETAILED DESCRIPTION

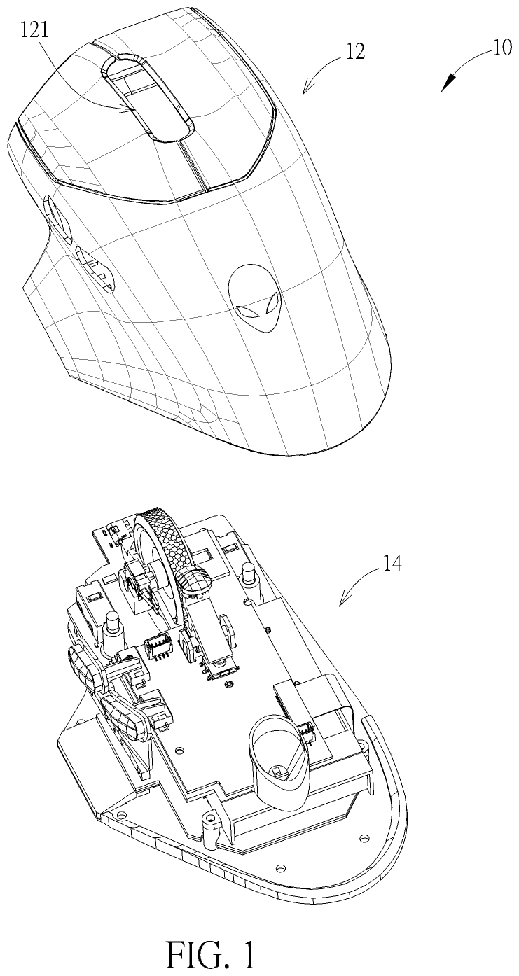

Please refer to FIG. 1. FIG. 1 is an exploded diagram of a part of a mouse 10 according to an embodiment of the present invention. The mouse 10 can include a case 12, a wheel device 14 and other components. The case 12 can cover and accommodate the wheel device 14 and other components. Some part of the wheel device 14 can protrude from the case 12, and a user can touch and control the wheel device 14 for inputting a control command. The wheel device 14 can have a lighting function so that the mouse 10 can provide preferred an artistic appearance. The said other component may be a circuit board, an operation processor, or related electronic components, which does not belong to an aim of the present invention, and a detailed description is omitted herein for simplicity.

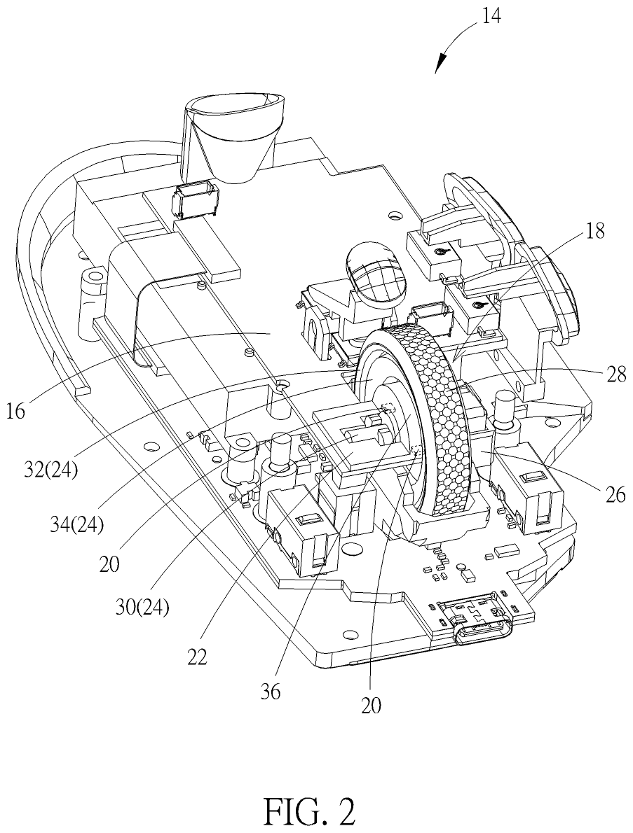

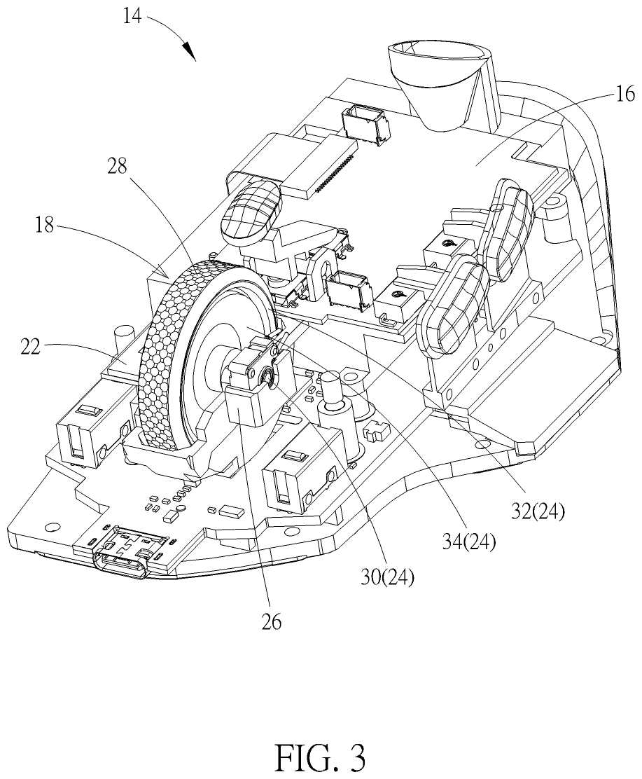

Please refer to FIG. 2 and FIG. 3. FIG. 2 and FIG. 3 are diagrams of the wheel device 14 in different views according to the embodiment of the present invention. The wheel device 14 can include a supporter 16, a wheel module 18, a lighting unit 20 and a sheltering component 22. The supporter 16 can be made of hard plastic material and used to hold the components. A type and a size of the supporter 16 are not limited to the embodiment of the present invention, and depend on a design demand. The wheel module 18 can include a wheel axle 24, an encoder 26 and a wheel component 28. The wheel axle 24 can be disposed on the supporter 16. The wheel component 28 can cover an outer edge of the wheel axle 24. The encoder 26 can be disposed adjacent to the wheel axle 24, and can utilize an optical detection technique to detect rotation parameters of the wheel axle 24 for acquiring the control command.

The wheel axle 24 can include an axle body 30, a wheel surface 32 and a wheel frame 34. The axle body 30 can be a rod structure disposed on the supporter 16 in a rotatable manner. The axle body 30 can be disposed on a center of the wheel frame 34, and the wheel surface 32 can be disposed on an outer surface of the wheel frame 34. The encoder 26 can be disposed on the axle body 30, and used to detect a feature's movement on the axle body 30 for deciding the rotation parameters of the wheel axle 24. The wheel component 28 can cover the wheel surface 32 of the wheel axle 24, and be an interface touched and controlled by the user. The lighting unit 20 can be disposed on the supporter 16 and located inside the wheel frame 34, and therefore an illumination beam emitted by the lighting unit 20 can be directly projected onto the wheel module 18.

The wheel module 18 of the wheel device 14 can partly protrude from the case 12, which means the case 12 can have an opening 121 to expose the wheel module 18. For preventing the illumination beam from leaking out of the opening 121 through two opposite sides of the wheel component 28, the present invention can dispose the sheltering component 22 on the supporter 16, and the sheltering component 22 can completely or partly cover the lighting unit 20 without hindering normal operation of the wheel module 18, so as to ensure that the user does not directly see the illumination beam of the lighting unit 20 through the opening 121. Generally, the sheltering component 22 can be made of light guiding material, translucent material or opaque material. An actual value of the transmittance coefficient of the sheltering component 22 can depend on the design demand. The sheltering component 22 can include an arch portion 36 disposed inside the wheel frame 34, and used to avoid the sheltering component 22 and the wheel frame 34 from structural interference in the normal operation of the wheel module 18.

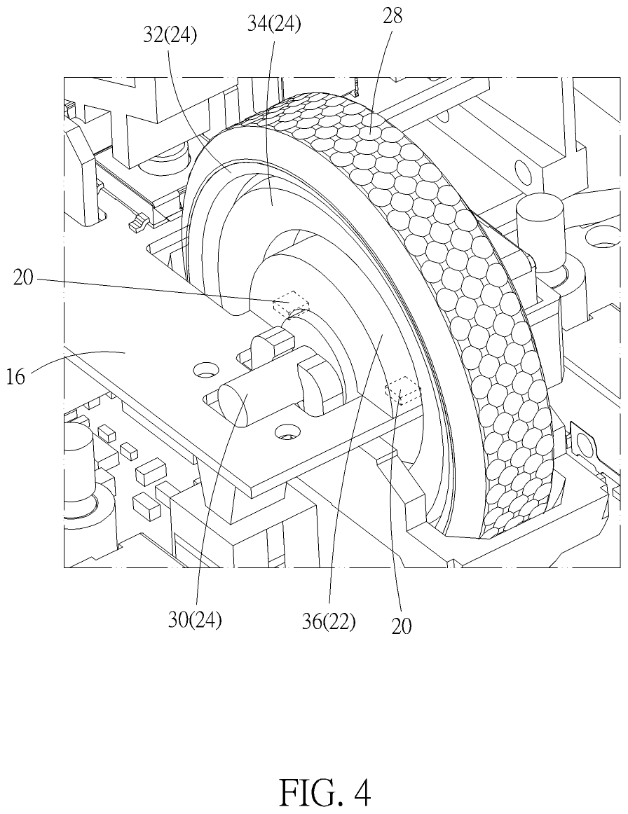

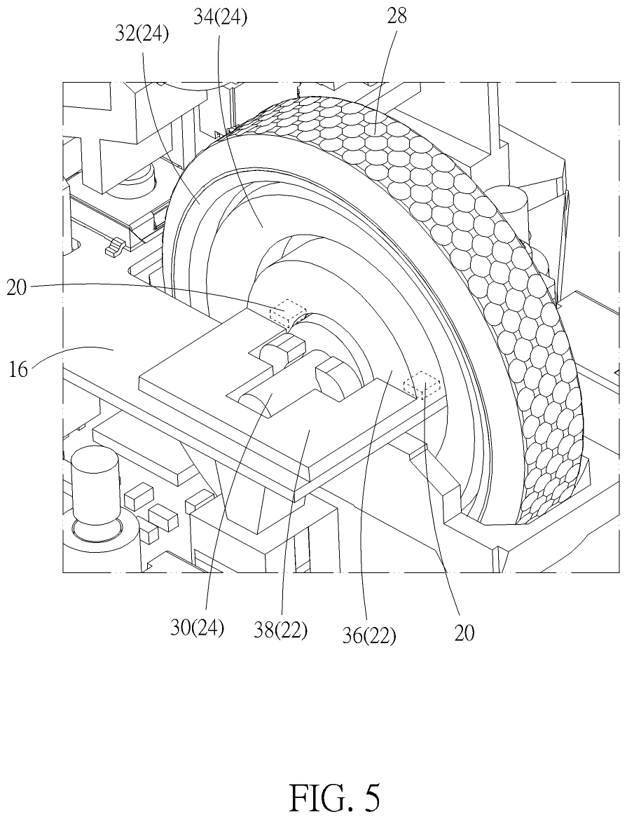

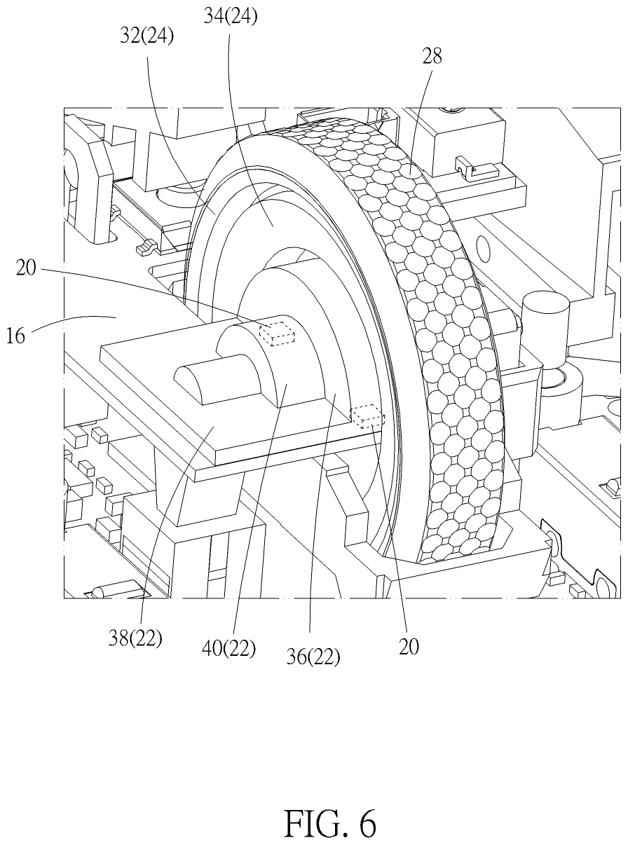

Please refer to FIG. 4 to FIG. 6. FIG. 4 to FIG. 6 are diagrams of the sheltering component 22 according to different embodiments of the present invention. As shown in FIG. 4, the sheltering component 22 may include the arch portion 36 only; the arch portion 36 is disposed on the wheel frame 34 and covers the lighting unit 20, and does not block the normal operation of the wheel module 18. As shown in FIG. 5, the sheltering component 22 can include the arch portion 36 and a stretching portion 38; the arch portion 36 can be disposed on the wheel frame 34 and covers the lighting unit 20. The stretching portion 38 can be connected to the arch portion 36 and disposed on the supporter 16. The stretching portion 38 can increase a contact dimension between the sheltering component 22 and the supporter 16 for preferred installation stability. As shown in FIG. 6, the sheltering component 22 can include the arch portion 36, the stretching portion 38 and an axle covering portion 40. Functions of the arch portion 36 and the stretching portion 38 are mentioned as above. The axle covering portion 40 can be located between the arch portion 36 and the stretching portion 38. The axle covering portion 40 can cover the axle body 30 to prevent the wheel module 18 from being polluted.

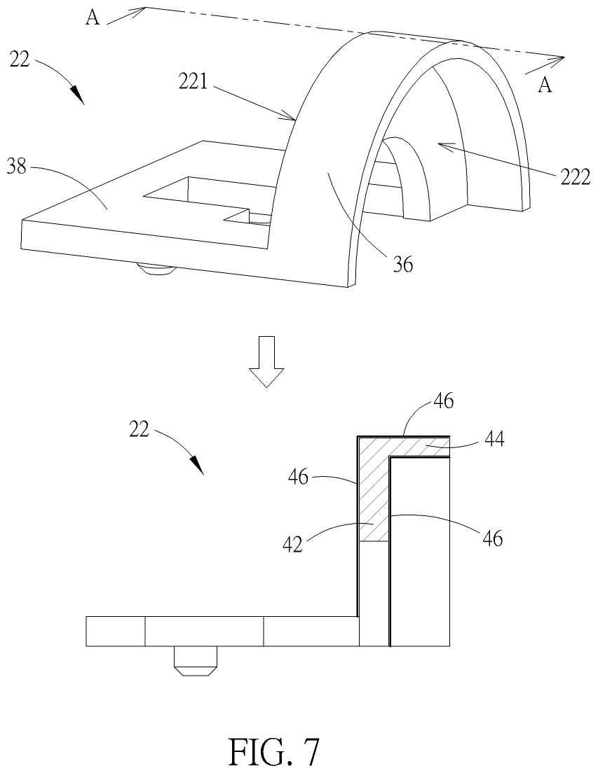

Please refer to FIG. 7. FIG. 7 is a diagram of the sheltering component 22 and a related sectional structure according to the embodiment of the present invention. As shown in FIG. 7, the section of the sheltering component 22 can be a bending structure, and the bending structure can include a vertical portion 42 and a lateral portion 44 connected to each other. The present invention can dispose a light sheltering layer 46 on an outer surface 221 of the sheltering component 22 opposite to the wheel frame 34. The light sheltering layer 46 can absorb and/or reflect beams, and actual material of the light sheltering layer 46 can depend on the design demand. The light sheltering layer 46 can be disposed on the vertical portion 42, so as to avoid the illumination beam of the lighting unit 20 from leakage through sides of the sheltering component 22. The light sheltering layer 46 can be optionally disposed on all part or a part of the lateral portion 44 and used to control an illumination intensity of the wheel module 18.

Besides, the present invention can further dispose the light sheltering layer 46 on an inner surface 222 of the sheltering component 22 facing the wheel frame 34. Accordingly, the light sheltering layer 46 can be disposed on the inner surface 222 of the vertical portion 42, and further optionally disposed on all part or a part of the inner surface 222 of the lateral portion 44, as shown in FIG. 7.

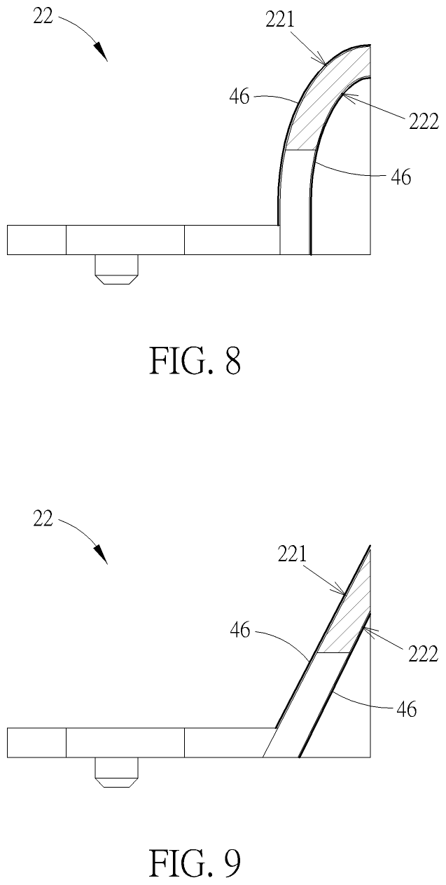

Please refer to FIG. 8 and FIG. 9. FIG. 8 and FIG. 9 are sectional views of the sheltering component 22 according to other embodiments of the present invention. As shown in FIG. 8, the section of the sheltering component 22 can be designed as an arc structure; as shown in FIG. 9, the section of the sheltering component 22 can be designed as an inclined plate structure. The light sheltering layer 46 can be optionally disposed on at least one of the outer surface 221 and the inner surface 222 of the sheltering component 22 shown in FIG. 8 and FIG. 9. Any sheltering component 22 capable of preventing the illumination beam of the lighting unit 20 from leakage through the sides of the wheel module 18 can conform to the design scope of the present invention, and the detailed description is omitted herein for simplicity.

In conclusion, the wheel device and the mouse of the present invention can cover the sheltering component on the lighting unit inside the wheel module. The sheltering component can guide the illumination beam of the lighting unit to project onto the wheel frame of the wheel axle inside the wheel module, and further can avoid the illumination beam from leakage through the sides of the wheel component inside the wheel module. The sheltering component can be only the arch portion used to cover the lighting unit, or be a combination of the arch portion and the stretching portion used to increase the installation stability, or be a combination of the arch portion, the stretching portion and the axle covering portion used to provide preferred covering effect. The section of the sheltering component is not limited to the bending structure, the arc structure and the inclined plate structure mentioned as above. Any sheltering component of preventing the illumination beam from leakage through the opening on the case without hindering the normal operation of the wheel module can be applied for the wheel device and the related mouse of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wheel device comprising:
a supporter;
a wheel module, comprising:
a wheel axle, comprising an axle body, a wheel surface and a wheel frame, the axle body being rotatably disposed on the supporter and further on a center of the wheel frame, the wheel surface being located on an outer surface of the wheel frame;
an encoder disposed adjacent to the axle body and adapted to detect rotation parameters of the wheel axle; and
a wheel component covering the wheel surface;
a lighting unit disposed on the supporter and located inside the wheel frame, and adapted to emit an illumination beam to the wheel module; and
a sheltering component disposed on the supporter and adapted to cover the lighting unit for preventing the illumination beam from leakage through two sides of the wheel component.

2. The wheel device of claim 1, wherein the sheltering component comprises an arch portion located inside the wheel frame.

3. The wheel device of claim 2, wherein the sheltering component further comprises a stretching portion connected to the arch portion and disposed on the supporter.

4. The wheel device of claim 3, wherein the sheltering component further comprises an axle covering portion connected between the arch portion and the stretching portion and disposed on the axle body.

5. The wheel device of claim 1, wherein a section of the sheltering component is a bending structure, or an arc structure, or an inclined plate structure.

6. The wheel device of claim 1, wherein the sheltering component is made of light guiding material and adapted to guide the illumination beam to project onto the wheel frame.

7. The wheel device of claim 1, wherein a light sheltering layer is disposed on an outer surface of the sheltering component opposite to the wheel frame.

8. The wheel device of claim 7, wherein the sheltering component comprises a vertical portion and a lateral portion, the light sheltering layer is disposed on the vertical portion, and further disposed on all part or a part of the lateral portion.

9. The wheel device of claim 7, wherein the light sheltering layer is adapted to absorb and/or reflect beams.

10. The wheel device of claim 1, wherein a light sheltering layer is disposed on an inner surface of the sheltering component facing the wheel frame.

11. A mouse comprising:
a case; and
a wheel device disposed inside the case, the wheel device comprising:
a supporter;
a wheel module, comprising:
a wheel axle, comprising an axle body, a wheel surface and a wheel frame, the axle body being rotatably disposed on the supporter and further on a center of the wheel frame, the wheel surface being located on an outer surface of the wheel frame;
an encoder disposed adjacent to the axle body and adapted to detect rotation parameters of the wheel axle; and
a wheel component covering the wheel surface;
a lighting unit disposed on the supporter and located inside the wheel frame, and adapted to emit an illumination beam to the wheel module; and
a sheltering component disposed on the supporter and adapted to cover the lighting unit for preventing the illumination beam from leakage through two sides of the wheel component.

12. The mouse of claim 11, wherein the sheltering component comprises an arch portion located inside the wheel frame.

13. The mouse of claim 12, wherein the sheltering component further comprises a stretching portion connected to the arch portion and disposed on the supporter.

14. The mouse of claim 13, wherein the sheltering component further comprises an axle covering portion connected between the arch portion and the stretching portion and disposed on the axle body.

15. The mouse of claim 11, wherein a section of the sheltering component is a bending structure, or an arc structure, or an inclined plate structure.

16. The mouse of claim 11, wherein the sheltering component is made of light guiding material and adapted to guide the illumination beam to project onto the wheel frame.

17. The mouse of claim 11, wherein a light sheltering layer is disposed on an outer surface of the sheltering component opposite to the wheel frame.

18. The mouse of claim 17, wherein the sheltering component comprises a vertical portion and a lateral portion, the light sheltering layer is disposed on the vertical portion, and further disposed on all part or a part of the lateral portion.

19. The mouse of claim 17, wherein the light sheltering layer is adapted to absorb and/or reflect beams.

20. The mouse of claim 11, wherein a light sheltering layer is disposed on an inner surface of the sheltering component facing the wheel frame.
